(19) United States
(12) Patent Application Publication
(10) Pub. No.: US 2007/0275151 A1
(43) Pub. Date: Nov. 29, 2007

(54) Frozen grits

(76) Inventor: Darryel Green, Birmingham, AL (US)

Correspondence Address: DARRYEL GREEN, 1632 5PL NW, BIRMINGHAM, AL, 35215, US

(21) Appl. No.: 10/800,313

(22) Filed: Aug. 20, 2004

(51) Int. Cl. A23L 1/00

(52) U.S. Cl. 426/618

(57) ABSTRACT

The concept of the newly developed product, Frozen Grits, is to readily provide a Conventional meal, or side dish, that has substantial serving capabilities and can be easily Obtained through effortless preparation. The product is precooked and prepackaged into Individual microwaveable bowls, or packages and come in units of four or six servings. Unlike its other frozen counterparts, Frozen Grits is designed to make preparation of a Meal more appealing and convenient to the consumer. The products formulation consists of removing the individually wrapped product from Unit, and place in microwave three minutes for preparation. Once product has reached Desired state; remove from microwave, stir, and serve. Uniquely, the product will be manufactured in a variety of bowl sizes and colors. These variations exist in order to meet needs of our targeted consumer-the general public. This product is marketable by any grocery stores.

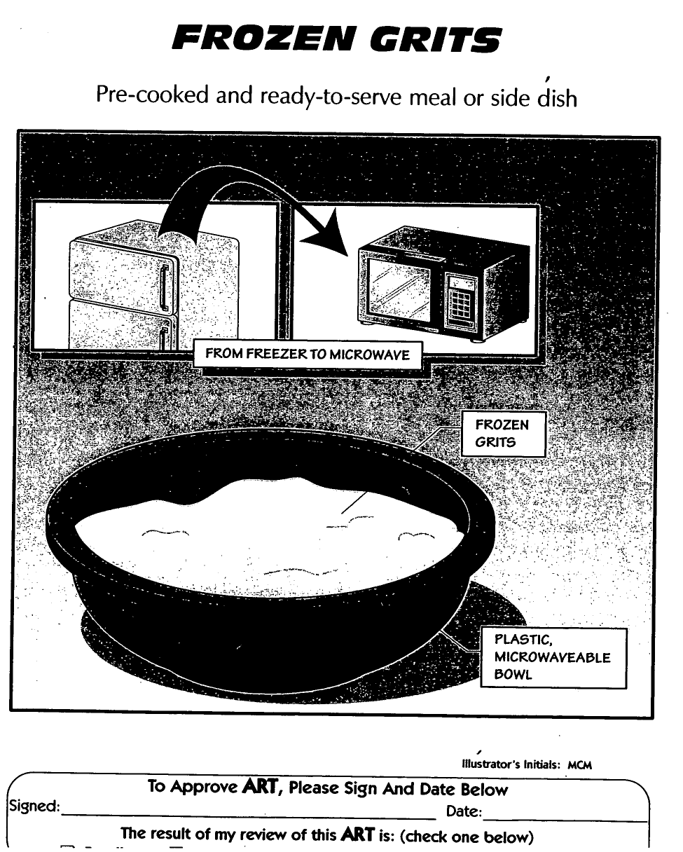

The concept of the newly developed product, Frozen Grits, is to readily provide a Conventional meal, or side dish, that has substantial serving capabilities and can be easily Obtained through effortless preparation. The product is precooked and prepackaged into Individual microwaveable bowls, or packages and come in units of four or six servings. Unlike its other frozen counterparts, Frozen Grits is designed to make preparation of a Meal more appealing and convenient to the consumer.

The products formulation consists of removing the individually wrapped product from Unit, and place in microwave three minutes for preparation. Once product has reached. Desired state; remove from microwave, stir, and serve.

Uniquely, the product will be manufactured in a variety of bowl sizes and colors. These variations exist in order to meet needs of our targeted consumer-the general public. This product is marketable by any grocery stores.

1. I, Darryel Green, claim that frozen grits are a safe and instant process to cook grits. It is designed so that anyone from children to adults can prepare and enjoy this conventional meal. The concept of producing this meal in a ready to serve bowl also makes the process much easier. This product is aimed to the general public, therefore; making it marketable in every community and every marketing outlets.
